(19) United States
(12) Patent Application Publication
(10) Pub. No.: US 2009/0202230 A1
(43) Pub. Date: Aug. 13, 2009

(54) VIDEO PLAYER WITH ACTION ON PAUSE

(76) Inventor: Lowell L. Winger, Waterloo (CA)

Correspondence Address: CHRISTOPHER P MAIORANA, PC;LSI Corporation, 24840 HARPER, SUITE 100, ST CLAIR SHORES, MI, 48080, US

(21) Appl. No.: 12/027,434

(22) Filed: Feb. 7, 2008

(51) Int. Cl. H04N 7/26

(52) U.S. Cl. 386/124

(57) ABSTRACT

The present invention concerns an apparatus comprising a source circuit and a processing circuit. The source circuit may be configured to present a compressed video signal. The processing circuit may be configured to present an output signal in response to (i) the compressed video signal and (ii) a pause signal. The output signal (a) may be in a format that may be displayed by a display device and (b) may comprise (i) a first video source when the pause signal is in a first state and (ii) a second source when the pause signal is in a second state.

### FIELD OF THE INVENTION

The present invention relates to video players generally and, more particularly, to a method and/or apparatus for implementing a video player with action on pause.

### BACKGROUND OF THE INVENTION

Conventional disc-based recorders and players (such as hard discs or optical discs) support scenarios in which the displayed video may be paused. A pause is normally a single frame presented as a still image. A user can pause video during playback of a recorded show, or can pause a live broadcast into a disk buffer. Such a pause may be used for the benefit of one viewer, typically the viewer in control of the remote control. Other viewers may want to have some viewable content during the paused interval. Current solutions are not flexible in the options that are provided during a pause. A similar problem exists during pause of pre-recorded discs used in optical disc players and recorders.

Existing solutions display the last video frame of the currently viewed content when a user hits the pause button. Some viewers may wish to have some alternative content displayed during pause.

It would be desirable to implement a video player that may provide alternate programming when a main program is paused.

### SUMMARY OF THE INVENTION

The present invention concerns an apparatus comprising a source circuit and a processing circuit. The source circuit may be configured to present a compressed video signal. The processing circuit may be configured to present an output signal in response to (i) the compressed video signal and (ii) a pause signal. The output signal (a) may be in a format that may be displayed by a display device and (b) may comprise (i) a first video source when the pause signal is in a first state and (ii) a second source when the pause signal is in a second state.

The objects, features and advantages of the present invention include providing a video player that may (i) provide alternate video content during a pause, (ii) provide alternate audio content during a pause, (iii) provide alternate audio/video content during a pause, (iv) store alternate content internally and/or externally and/or (v) provide one or more management routines or sources for accessing alternate content.

### BRIEF DESCRIPTION OF THE DRAWINGS

These and other objects, features and advantages of the present invention will be apparent from the following detailed description and the appended claims and drawings in which:

FIG. 1 is a block diagram illustrating a context of the present invention;

FIG. 2 is a block diagram of an embodiment of the present invention;

FIG. 3 is a diagram illustrating the operation of a remote controller used with the present invention; and

FIG. 4 is a diagram illustrating the presentation of live content and paused content.

### DETAILED DESCRIPTION OF THE PREFERRED EMBODIMENTS

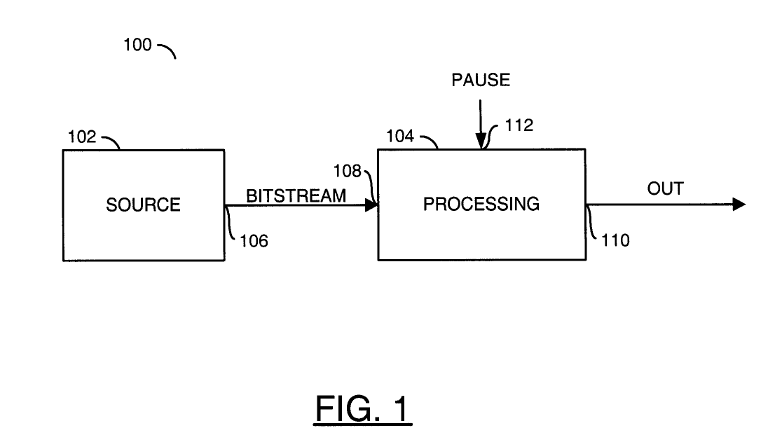

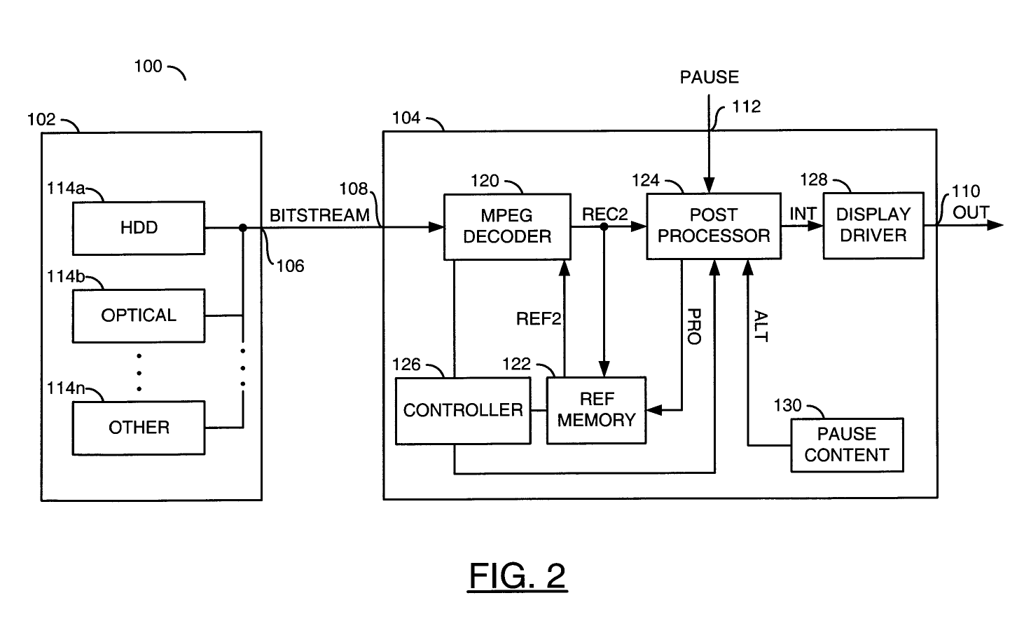

Referring to FIG. 1, a block diagram of a system 100 is shown in accordance with the present invention. The system 100 generally comprises a block (or circuit) 102 and a block (or circuit) 104. The block 102 may be implemented as a source circuit. The circuit 102 may have an output 106. The circuit 102 may present a signal (e.g., BITSTREAM). The signal BITSTREAM may be presented to an input 108 of the block 104. The block 104 may be implemented as a processing circuit. The circuit 104 may have an output 110 that may present a signal (e.g., OUT). The signal OUT may be an output signal presented to a display device, such as a monitor. The circuit 104 may also have an input 112 that may receive a signal (e.g., PAUSE). The signal PAUSE may be a control signal that may initiate a pause operation of the normal video presented on the signal OUT and initiate alternate video (to be described in more detail in connection with FIG. 2). The signal PAUSE may have a first state (e.g., a digital “ON”) that may enable viewing of the video from the signal BITSTREAM and a second state (e.g., a digital “OFF”) that may pause the original signal, and present the paused content.

Referring to FIG. 2, a more detailed block diagram of the system 100 is shown in accordance with a preferred embodiment of the present invention. The circuit 104 generally comprises a number of source devices 114a-114n. The source device 114a may be implemented as a hard disc drive. The source device 114b may be implemented as an optical disc drive, such as a DVD, a HD-DVD, a Blu-Ray disc, or another type of optical disc. The source device 114n may be implemented as some other type of device. For example, the device 114n may be implemented as a flash drive, an internal memory, a personal video recorder (PVR), a digital disc recorder (DDR), or another type of storage and/or memory device. In another example, the device may be implemented as an Internet Protocol Television (IPTV) device or set-top box (e.g., a device that receives television signals over an Internet Protocol Network. While a number of source devices 114a-114n are shown, one example implementation of the system 100 normally has a single type of source device. Other example implementations of the system 100 may combine a hard disc drive with an optical disc reader and/or writer. Other combinations of the source devices 114a-114n may be implemented. Any of the source devices 114a-114n may present the signal BITSTREAM.

The signal BITSTREAM is normally a compressed video signal. In particular, the signal BITSTREAM normally needs to be decoded prior to display. By implementing the signal BITSTREAM as a compressed video signal, the source devices 114a-114n may store the video signal efficiently. The signal BITSTREAM may be compliant with MPEG-2, MPEG-4 Part 2, Divx, H.262, H.263 or other similar codecs. Other codecs may be implemented to meet the criteria of a particular application.

The circuit 104 may decode the compressed pictures received in the signal BITSTREAM to create the signal OUT. The circuit 104 generally comprises a module (or block or circuit) 120, a module (or block or circuit) 122, a module (or block or circuit) 124, a module (or block or circuit) 126, an optional module (or block or circuit) 128 and a module (or block or circuit) 130. The module 120 may receive the signal BITSTREAM. The circuit 120 may present a signal (e.g., REC2). The signal REC2 may present reconstructed pictures to the module 122 and the module 124. The module 122 may present a signal (e.g., REF2) carrying reference pictures to the module 120. A signal (e.g., PRO) carrying post-processed pictures may be presented from the module 124 to the module 122. The module 124 may also present a signal (e.g., INT) carrying intermediate post-processed pictures to the module 128. The module 130 may generate and present a signal (e.g., ALT). The signal ALT may represent alternate content that may be presented when the signal PAUSE is activated. The module 126 may be in communication with the modules 120, 122 and 124 to send and receive information and commands used in both (i) controlling the generation of and (ii) the use of the non-post-processed reference pictures and the post-processed references pictures.

The module 120 generally implements a decoder module. The module 120 may be operational to decode (reconstruct) the compressed pictures received in the signal BITSTREAM in compliance with the codec used to encode the compressed pictures. The reconstructed pictures may be presented to the module 122 and to the module 124 in the signal REC2.

The module 122 generally implements a reference memory. The module 122 may be operational to buffer the non-post-processed reference pictures and the post-processed reference pictures. The non-post-processed reference pictures may be received from the module 120 via the signal REC2. The post-processed reference pictures may be received from the module 124 via the signal PRO. Each of the reference pictures (e.g., non-post-processed and post-processed) may be presented to the module 120 in the signal REF2 to support motion-compensated decoding. Buffering and distribution of the reference pictures may be performed according to commands issued by the module 126.

The module 124 generally implements a post-processor module. The module 124 may be operational to post-process the reconstructed pictures (e.g., I-pictures, P-pictures and B-pictures) received via the signal REC2. All of the post-processed pictures may be presented as intermediate pictures in the signal INT. Some post-processed pictures (e.g., some to all of the P-pictures) may be sent to the module 122 in the signal PRO as new post-processed reference pictures. The post-processing generally includes, but is not limited to, full deblock filtering, partial deblock filtering (e.g., filtering only at the block grid boundaries), mosquito noise reduction, interlaced format to progressive format conversions (e.g., deinterlacing) and/or comfort noise addition.

The module 126 generally implements a controller module. The module 126 may be operational to determine which reconstructed pictures are stored in the module 122 as non-post-processed reference pictures and which reconstructed pictures are stored as post-processed-reference pictures. Generally, (i) all reconstructed I-pictures and (ii) some to all of the P-pictures may be stored as non-post-processed reference pictures. Some to all of the P-pictures may be stored in the module 122 as post-processed-reference pictures. Most, if not all, of the B-pictures may be decoded using the post-processed reference pictures. Furthermore, most, if not all, of the P-pictures may be decoded using the non-post-processed reference pictures. In some embodiments, a few of the P-pictures may be decoded using the post-processed reference pictures. In some embodiments, a few of the B-pictures may be decoded using the non-post-processed reference pictures.

The module 128 generally implements a display driver module. The module 128 may be operational to generate the signal OUT based on the signal INT. The signal OUT may be one or more analog video signals and/or one or more digital video signals. The signal OUT generally comprises a sequence of progressive-format frames and/or interlace-format fields. The signal OUT may include synchronization signals suitable for synchronizing a display with the video information. The signal OUT may be generated in analog form as, but is not limited to, an RGB (Red, Green, Blue) signal, an EIA-770 (e.g., YCrCb) signal, an S-video signal and/or a Composite Video Baseband Signal (CVBS). In digital form, the signal OUT may be generated as, but is not limited to, a High Definition Multimedia Interface (HDMI) signal, a Digital Video Interface (DVI) signal and/or a BT.656 signal. The signal OUT may be formatted as a standard definition signal or a high definition signal. In applications where the circuit 104 implements a pure transcoder, the module 128 may be eliminated.

The signal BITSTREAM may be compliant with a VC-1, MPEG, Divx and/or H.26x codecs. The MPEG/H.26x codecs generally include H.261, H.264, H.263, MPEG-1, MPEG-2, MPEG-4 and H.264/AVC. The MPEG codecs may be defined by the Moving Pictures Expert Group, International Organization for Standards, Geneva, Switzerland. The H.26x codecs may be defined by the International Telecommunication Union-Telecommunication Standardization Sector, Geneva, Switzerland. The VC-1 codec may be defined by the document Society of Motion Picture and Television Engineer (SMPTE) 421M-2006, by the SMPTE, White Plains, N.Y. The Divx codec may be defined by DivX, Incorporated, San Diego, Calif.

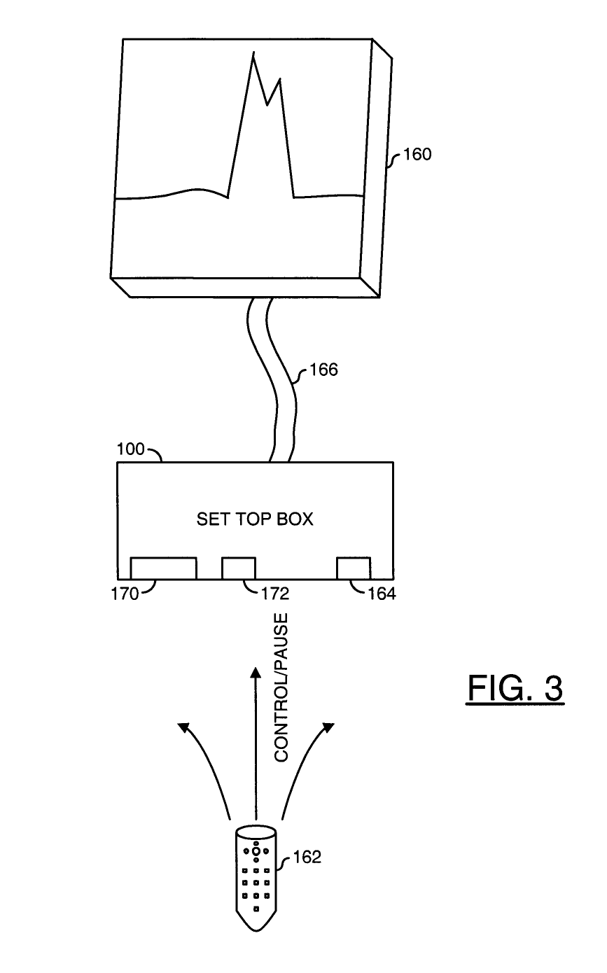

The processing circuit 104 may be configured to present the signal OUT in response to the signal BITSTREAM and the signal PAUSE. The signal OUT may be in a format that may be displayed by a display device. The signal OUT may be generated as (i) a first video source from the signal BITSTREAM when the signal PAUSE is in a first state and (ii) a second source from the pause content block 130 when the signal PAUSE is in a second state. While the signal PAUSE is shown as a discrete input to the circuit 104, the signal PAUSE may be included with a number of other control signals that are typically received from a remote control device. Such a remote control device (e.g., either inferred (IR) or radio frequency (RF)) may be presented from a remote control (to be described in more detail in connection with FIG. 3).

The paused content from the circuit 130 may be implemented in a variety of ways. For example, the paused content may be new content not found in the signal BITSTREAM, or content that was previously skipped during playback. For example, the system 100 may be configured to display a previous video field or frame of the main/current program. The system 100 may be configured to display a previous video frame or field of the main/current program on one portion of the screen (e.g., in a PIP frame or PIP surround), while displaying on of the other alternatives in another portion of the screen. The system 100 may be configured to mute or not mute accompanying audio of the alternative displayed content. In another example, the system 100 may be configured to play music from a user-loaded file, from a broadcast music channel, or from another music source.

Referring to FIG. 3, the system 100 is shown connected to a display 160. A remote control 162 may present a signal (e.g., CONTROL/PAUSE). The signal CONTROL/PAUSE normally includes the signal PAUSE. The signal CONTROL/PAUSE may be presented either through an infrared remote (IR) control, a radio frequency (RF) remote control, a combination of IR and RF or other types of remote control. If an infrared remote control is used, an infrared pickup 164 on the set top box may receive the signal CONTROL/PAUSE. A cable 166 is normally used to connect the set top box 100 to the display device 160.

The alternative content (or pause content) may be implemented as a one or more of a number of audio and/or video sources. In one example, the pause content may include on-demand advertising or promotional material via content-provider broadcast. In another example, the pause content may include advertising or promotional material previously recorded to a disc (e.g., the most recently available commercial/advertising block for the current/main program). Such content may be identified by an automated commercial/advertising detection process, or by tagging video for which the user has engaged a fast-forward control (or other trickplay control) during playback. In another example, the pause content may include a user selected JPEG image, loaded by the user from an interface 172. The interface 172 may be a Universal Serial Bus (USB) or other external interface. A card reader 170 may also be implemented to receive additional content. The particular type of card reader 170 may be varied to meet the design criteria of a particular implementation.

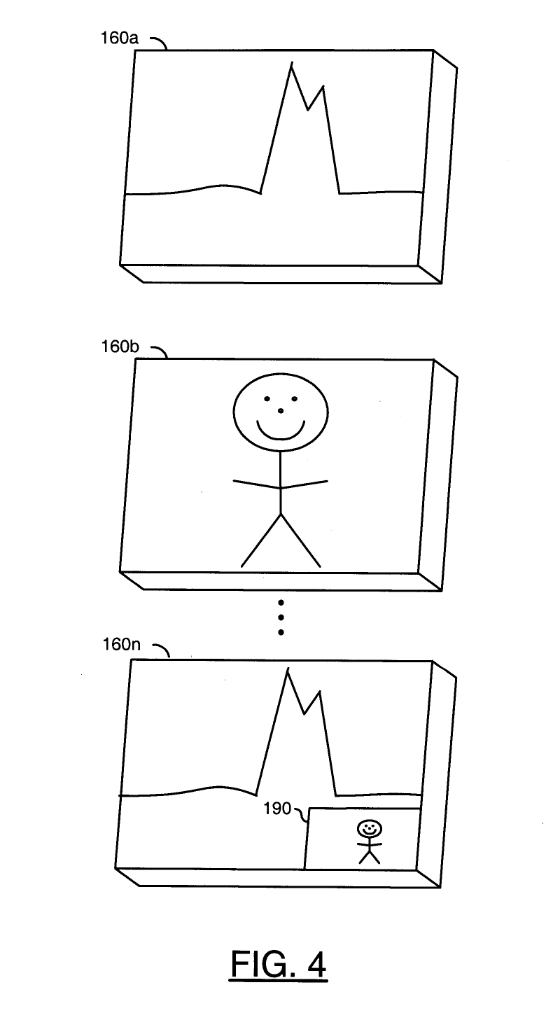

Referring to FIG. 4, examples of images are shown as a display 160a, a display 160b and a display 160n. The display 160a illustrates the primary video image received from the signal BITSTREAM. The display 160b illustrates alternate pause material. The system 100 may switch between images shown on the display 160a and 160b in response to the signal PAUSE. The display 160n illustrates a picture in picture window 190 illustrating the pause content. As discussed, the alternate pause material may be video, audio or a combination of video and/or audio.

In one implementation, a user may configure the action of the system 100 during pause (e.g., to play a selected music file, or music from a selected music library). Such an action may include tuning to a particular music channel. In one example, such an action may include displaying a selected still image or image from a selected library of images. In another example, such an action may include displaying recorded commercials from the main video program. In another example, such an action may include displaying commercials, advertisements, and/or promotions received on-demand from a service provider.

In one implementation, the pause content may be selectable based on time of day. For example, the pause content used in the morning may be different than the pause content used in the evening. A user content-restriction bypass may be used to select the pause content. If a bypass is enabled, material appropriate only for adult viewing may be bypassed. Such a selection may be based on the state of the player (e.g., time of day and/or content-restriction bypass options).

In one example, when the signal PAUSE is engaged, the system 100 may raise a menu of items from which a particular action may be selected. By providing a variety of options, the present invention provides a superior pause experience to the player user. For example, a very rich pause experience may be implemented for some devices, with audio, video, and still image options available from multiple live and recorded sources. The system 100 may be configurable with the various available options that may enhance the user experience further.

Additionally, the pause content may be presented during rewind (e.g., or generally in response to any trickplay command). For example, a slideshow may be presented in the picture-in-picture (PIP) window 190 in response to a fast-forward (FF) command. In another example, selected music may be played while a user is searching in a video program for a desired spot to start watching from.

In another example, different time intervals may be used to select a particular pause feature. For example, a regular pause may be implemented for a predefined interval (e.g., 10 seconds), then a switch to the alternative pause content may be implemented. The ten second intervals provide only for an example. Additional time intervals of less than ten seconds or more than ten seconds may also be implemented. By implementing a time interval before the pause action occurs, potentially distracting features may be avoided. The system 100 may enable similar options during fast-forward (e.g., play selected audio instead of muting during a fast-forward). A slideshow of stills from a library may be enabled during a pause and/or fast-forward.

In another example, a rewind or other trickplay feature may trigger the present invention. For example, a slideshow in the PIP window 190 may be used, or selected music may be played while a user is searching in a video program for the spot that they want to start watching from.

While the invention has been particularly shown and described with reference to the preferred embodiments thereof, it will be understood by those skilled in the art that various changes in form and details may be made without departing from the scope of the invention.

1. An apparatus comprising:
a source circuit configured to present a compressed video signal; and
a processing circuit configured to present an output signal in response to (i) said compressed video signal and (ii) a pause signal, wherein said output signal (a) is in a format that may be displayed by a display device and (b) comprises (i) a first video source when said pause signal is in a first state and (ii) a second source when said pause signal is in a second state.

2. The apparatus according to claim 1, wherein said second source comprises a video source.

3. The apparatus according to claim 1, wherein said second source comprises an audio source.

4. The apparatus according to claim 1, wherein said source circuit comprises a personal video recorder (PVR).

5. The apparatus according to claim 2, wherein said second source is configurable based on a current time-of-day.

6. The apparatus according to claim 2, wherein said second source is configurable based on a content playback restriction.

7. The apparatus according to claim 2, wherein said source circuit comprises a Blu-Ray player.

8. The apparatus according to claim 2, wherein said source circuit comprises an Internet Protocol Television (IPTV) set-top box.

9. The apparatus according to claim 1, wherein said second source is configurable from a selectable list each time said pause signal is in said first state.

10. The apparatus according to claim 1, wherein said second source is configurable through a device setup.

11. The apparatus according to claim 1, wherein said second source is configured once a first time pause is engaged and used for each subsequent pause.

12. The apparatus according to claim 1, wherein said second source is configurable based on material identified by tagging video sections during previous fast-forward playback.

13. The apparatus according to claim 2, wherein said second source comprises material tagged for playback during paused periods of viewing.

14. The apparatus according to claim 1, wherein said second source is used after waiting a pre-determined time after said pause signal enters said second state.

15. The apparatus according to claim 2, wherein said display device displays said second source in a picture-in-picture frame.

16. The apparatus according to claim 15, wherein said picture-in-picture frame is configurable.

17. An apparatus comprising:
a source circuit configured to present a compressed video signal; and
a processing circuit configured to present an output signal in response to (i) said compressed video signal and (ii) a trickplay signal, wherein said output signal (a) is in a format that may be displayed by a display device and (b) comprises (i) a first video source when said trickplay signal is in a first state and (ii) a second source when said trickplay signal is in a second state.

18. The apparatus according to claim 17, wherein said trickplay signal comprises a fast-forward signal.

19. The apparatus according to claim 17, wherein said trickplay signal comprises a rewind signal.

20. An apparatus comprising:
means for presenting a compressed video signal; and
means for presenting an output signal in response to (i) said compressed video signal and (ii) a trickplay signal, wherein said output signal (a) is in a format that may be displayed by a display device and (b) comprises (i) a first video source when said trickplay signal is in a first state and (ii) a second source when said trickplay signal is in a second state.
